(19) United States
(12) Patent Application Publication
(10) Pub. No.: US 2018/0241011 A1
(43) Pub. Date: Aug. 23, 2018

(54) ELECTROCHEMICAL CELL CONTAINER HAVING PRINTED INDICIA THEREON

(71) Applicant: Energizer Brands, LLC, St. Louis, MO (US)

(72) Inventor: Maria Verikakis, Westlake, OH (US)

(21) Appl. No.: 15/899,687

(22) Filed: Feb. 20, 2018

Related U.S. Application Data
(60) Provisional application No. 62/461,993, filed on Feb. 22, 2017.

(51) Int. Cl. H01M 2/02; G09F 3/04; H01M 2/08; H01M 2/26

(52) U.S. Cl. CPC H01M 2/022; H01M 2/0267; H01M 2/0275; H01M 2/26; G09F 3/04; H01M 2/08; H01M 2/0277

(57) ABSTRACT

Various embodiments are directed to electrochemical cells having ink-based indicia printed thereon and methods for printing ink-based indicia on electrochemical cells. Specifically, various embodiments comprise a container containing electrochemically active materials, such as an anode and a cathode in electrical contact with the container, a negative cover sealed over an open end of the container and in electrical contact with the anode, and an ink-based indicia printed on an external surface of the container. The electrochemical cell may additionally comprise an insulating composition, such as a preformed ring or form-in-place insulator, surrounding the negative cover to impede unintentional short circuiting between the negative cover and positively charged container. The exterior of the electrochemical cell may additionally be coated a clear final coating layer to protect the electrochemical cell and the printed indicia.

### CROSS REFERENCE TO RELATED APPLICATIONS

This application claims benefit of U.S. Provisional Application No. 62/461,993, filed on Feb. 22, 2017, the contents of which as are hereby incorporated by reference in its entirety.

### BACKGROUND

Electrochemical cells (e.g., alkaline batteries, lithium batteries, and/or other primary and secondary batteries) are commercially available in cell sizes commonly known as LR6 (AA), LR03 (AAA), LR14 (C) and LR20 (D), among others. The cells have a cylindrical shape that must comply with the dimensional standards that are set by organizations such as the International Electrotechnical Commission. The electrochemical cells are utilized by consumers to power a wide range of electrical devices, for example, clocks, radios, toys, electronic games, film cameras generally including a flashbulb unit, as well as digital cameras.

Conventional electrochemical cells generally include a conductive container (e.g., a steel can) containing a number of internal electrochemical cell components collectively configured to produce electrical power. The conductive container itself is often in electrical contact with a positive electrode, commonly referred to as a cathode, within the container and therefore the container itself may act as a positive terminal for the electrochemical cell.

The container itself forms a portion of the overall enclosure encasing the internal electrochemical cell components. The enclosure often also contains a conductive negative terminal in electrical contact with a negative electrode commonly referred to as an anode within the electrochemical cell. The negative cover is electrically isolated from the positively charged container, generally by a gasket/seal that serves to both isolate the positive and negative terminals of the electrochemical cell and to seal the enclosure formed by the container and the negative cover.

Sealed electrochemical cells have historically been wrapped with a thin plastic label (e.g., a heat-shrink plastic label) having printed indicia thereon. The plastic label provides information to consumers about the electrochemical cell, such as the brand name, required government and/or industry disclosures, instructions for use, terminal labels, size information, and/or the like. The plastic label often covers the sides of the electrochemical cell while leaving a portion of the negative cover exposed on a first end of the cell and a portion of a positive terminal (in electrical contact with the container) exposed on a second, opposite end of the cell. The label thereby impedes unintended short circuits caused by conductors contacting both a portion of the container and a portion of the negative cover simultaneously. This plastic label has a non-negligible thickness, and accordingly the overall width/diameter of an electrochemical cell is measured across the diameter of the electrochemical cell, between points on the outermost surface of the plastic label. Because the width/diameter of these cells are subject to the strict tolerance limits set by industry groups, the thickness of the label serves as a physical limitation to expanding the overall size of the cell to accommodate additional electrochemical cell components within the interior of the cell container.

Because consumers are constantly seeking high-performance electrochemical cells, a constant need exists for electrochemical cell configurations that increase the discharge capacity of electrochemical cells.

### BRIEF SUMMARY

Various embodiments are directed to electrochemical cells that include ink-based indicia printed directly onto the external surface of an electrochemical cell canister that is in electrical connection with an electrochemical electrode (e.g., a cathode). Accordingly, a separate label, such as a plastic shrink-wrap label need not be applied to the external surface of the container. The electrochemical cells also incorporate insulating compositions surrounding the negative cover of the electrochemical cell, to impede unintentional electrical contact between the electrically charged canister (e.g., positively charged) and an oppositely charged electrical terminal (e.g., a negative terminal).

Various embodiments are directed to an electrochemical cell comprising a container having a closed bottom end, an open top end, and side walls extending between the bottom and top ends; electrochemically active materials disposed in said container, said electrochemically active materials comprising a cathode and an anode, wherein the cathode is in electrical contact with the container; and a negative cover disposed in the open top end of said container for closing the open top end of said container, wherein the negative cover is in electrical contact with the anode and the negative cover is electrically insulated from the container; and wherein an external surface of the container has a printed indicia thereon, said printed indicia comprising an ink.

In certain embodiments, the electrochemical cell further comprises an insulating composition covering a portion of the container surrounding the negative cover such that a planar member cannot directly and simultaneously contact the container and the negative cover. Moreover, the insulating composition may comprise a plastic ring adhered to the portion of the container surrounding the negative cover. In certain embodiments, the insulating composition comprises at least one composition selected from: a thermoplastic, a thermoset material, an epoxy, a varnish, a UV-cured sealant, a urethane, a polyurethane, or a rubber. Moreover, the insulating composition may be defined by a portion of an annular seal configured to electrically insulate the negative cover from the container, wherein the portion of the annular seal may extend around the open top of said container to cover at least a portion of the external surface of the container. The ink of certain embodiments is selected from: a solvent-based ink, an aqueous-based ink, a UV-cure ink, an eco-solvent based ink, or a latex based ink. Moreover, the electrochemical cell may further comprise a final coating layer external to the printed indicia. The final coating layer may comprise a clear composition selected from: a varnish, an epoxy, a urethane, or a polyurethane.

In certain embodiments, the electrochemical cell further comprising a primer layer between the printed indicia and the external surface of the container. Moreover, the closed bottom end of the container may further define a protruding nub integrally formed with the container, the closed bottom end of the container defining a positive terminal of the electrochemical cell. The electrochemical cell may further comprise a positive terminal secured relative to the closed bottom end of the container, the positive terminal defining a protruding nub integrally formed with the positive terminal. The positive terminal may be welded onto the closed bottom end of the container. The container may comprise steel in certain embodiments.

Certain embodiments are directed to a method for forming an electrochemical cell. the method may comprise: providing a container having a closed bottom end, an open top end, and side walls extending between the bottom and top ends; printing ink-based indicia onto an external surface of said side walls of said container; positioning electrochemically active materials within said container, wherein the electrochemically active materials comprise a cathode and an anode; placing a negative cover over the open top end of said container; sealing the open top end of said container around the negative cover; and forming an insulating composition on a portion of said side walls of said container around a perimeter of the negative cover.

In certain embodiments, forming the insulating composition on a portion of said side walls of said container comprises adhering an insulating ring onto said portion of said side walls. Moreover, forming the insulating composition on a portion of said side walls of said container may comprise applying the insulating composition onto said portion of said sidewalls; and curing the insulating composition such that the insulating composition adheres to said portion of said side walls.

In certain embodiments, the insulating material comprises a thermoplastic, and wherein curing the insulating composition comprises cooling the insulating composition. Moreover, the insulating material may comprise a UV-cure material, and wherein curing the insulating composition comprises exposing the container to a UV-light. Certain embodiments further comprise applying a final coating layer onto the container, external to the printed ink-based indicia. Moreover, certain embodiments further comprise securing a positive terminal onto an external surface of the closed bottom end of the container, wherein the positive terminal defines a protruding nub integrally formed with the positive terminal. In certain embodiments, securing the positive terminal onto the external surface of the closed bottom end of the container comprises welding the positive terminal onto the external surface of the closed bottom end of the container.

### BRIEF DESCRIPTION OF THE SEVERAL VIEWS OF THE DRAWINGS

Reference will now be made to the accompanying drawings, which are not necessarily drawn to scale, and wherein:

FIG. 1 is a longitudinal cross sectional view of an electrochemical cell according to one embodiment;

FIG. 1A is a sectional view of a portion of the electrochemical cell shown in FIG. 1;

FIG. 2 is an end-on view of the electrochemical cell shown in FIG. 1; and

FIG. 3 is a longitudinal cross sectional view of an electrochemical cell according to another embodiment.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

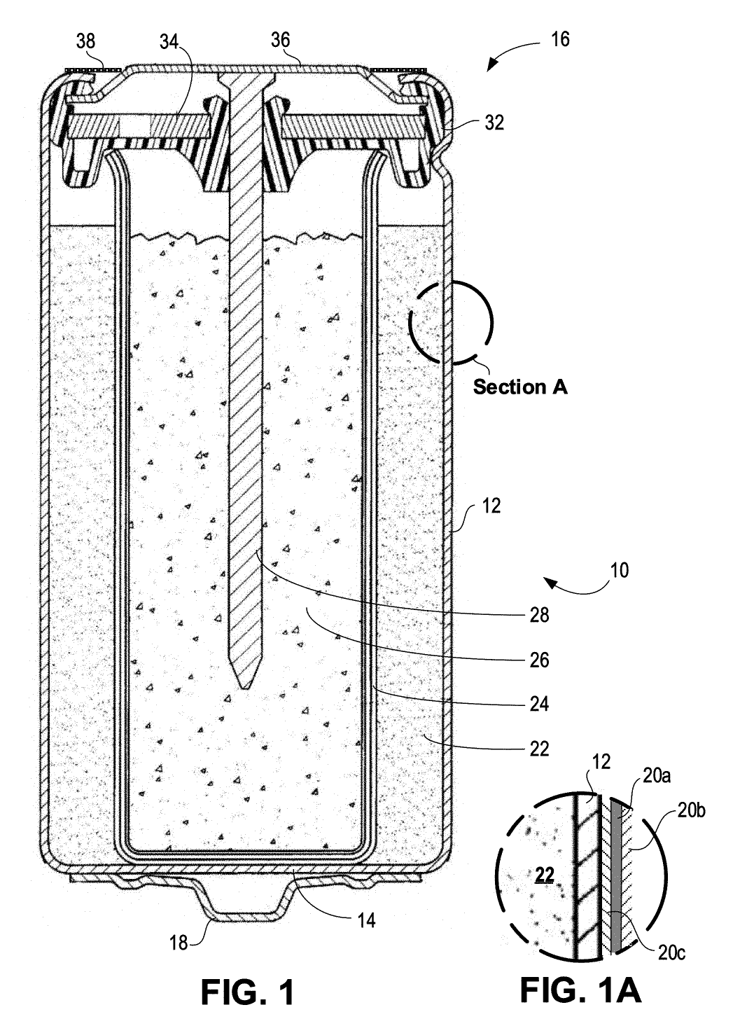

Referring to FIG. 1, a cylindrical electrochemical cell 10, such as an alkaline cell according to one example, is shown therein. Electrochemical cell 10 includes a canister 12 (e.g., a cylindrical steel canister, a cylindrical aluminum canister, a rectangular canister, a cylindrical zinc can, and/or the like) having a closed bottom end 14, an open top end 16, and cylindrical side walls extending between the top and bottom ends. In various embodiments, the canister 12 may be formed from a canister blank, such as a generally planar, circular sheet of material (e.g., steel) that is stamped into the elongated cylindrical canister shape. During the stamping process, the canister blank may be stretched and/or deformed into the final canister shape by a high-pressure forming die.

In the illustrated embodiment of FIG. 1, the canister 12 further includes a positive cover 18 welded or otherwise attached to the closed bottom end 14. The positive cover 18 may be formed of plated steel, with a protruding nub that forms the positive contact terminal of cell 10 at a central region of the cover 18. In such embodiments, the outer periphery of the positive cover 18 may have a chamfered and/or smoothed edge to remove any burrs or sharp portions of the outer periphery of the positive cover 18.

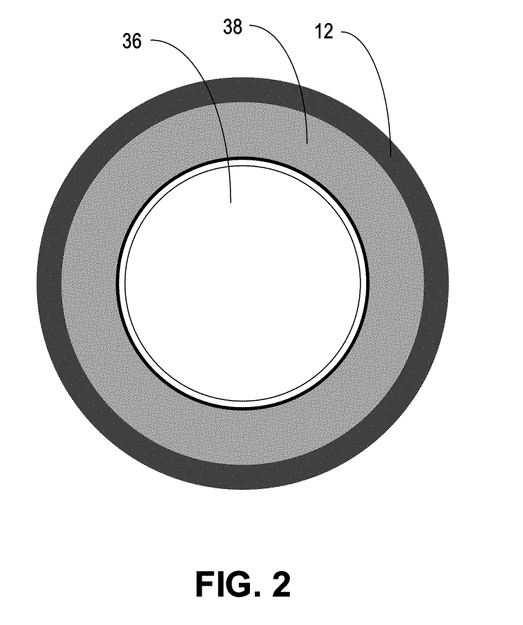

Although not shown, in various embodiments, the closed bottom end 14 of canister 12 may not include the positive cover 18 shown in FIGS. 1 and 2. In such embodiments, the closed bottom end 14 of canister 12 may encompass a protruding nub integrally formed at a center portion of the closed bottom end 14. Accordingly, the closed bottom end 14 of canister 12 may form the positive contact terminal of cell 10. In embodiments in which the closed bottom end 14 of canister 12 forms the positive contact terminal of cell 10, the electrochemical cell 10 does not define any sharp edges, burrs, and/or the like at the positive contact terminal of cell 10. Moreover, because the closed bottom end 14 of the canister 12 forms the positive contact terminal of cell 10, without a separate positive cover 18 (which has a non-negligible thickness), the interior dimensions of canister 12 may be proportionally increased (e.g., the length of the canister 12 may be elongated) relative to a similarly configured electrochemical cell 10 having a separate positive cover 18 secured relative to the canister 12.

A tubular shaped cathode 22 is formed about the interior surface of canister 12 and is in electrical contact with canister 12. The cathode 22 may be formed in a tubular shape in can 12 using ring molding techniques or impact molding techniques, as is generally known in the battery art. According to one example, the cathode 22 comprises a mixture of manganese dioxide, graphite, potassium hydroxide solution (electrolyte), and additives. A separator 24, which may include a cup-shaped separator, preferably formed of a non-woven fabric that prevents migration of any solid particles in the cell 10, is disposed about the interior surface of cathode 22. An anode 26 is disposed with electrolyte inside the separator 24, generally in the center of the cell 10. According to one example, the anode 26 is preferably formed of zinc powder, a gelling agent, and additives. Disposed in contact with the anode 26 is a current collector 28, which may include a brass nail having an elongated body and an enlarged head at one end. Accordingly, the cathode 22 is configured as the cell's positive electrode, and the anode 26 is configured as the cell's negative electrode. While a bobbin type cell construction is shown, the anode 26, cathode 22, and separator 24 may alternately be configured in a spiral wound configuration for a jelly-roll cell construction, or otherwise configured for either primary or secondary cells, without departing from the teachings of the present disclosure.

The electrochemical cell 10 further includes a collector and seal assembly which seals closed the open end 16 of canister 12. Included in the collector and seal assembly is the current collector 28, an annular seal 32 (e.g., a polymeric seal, such as a nylon seal), and an inner metal cover 34. The current collector 28, annular seal 32, and inner cover 34 may be pre-assembled and inserted into the open end 16 of canister 12 as an assembled unit. The inner cover 34, which is preferably formed of a rigid metal, is provided to increase the rigidity and support the radial compression of annular seal 32, thereby improving the sealing effectiveness. The inner cover 34 is configured to contact the seal's inner upstanding wall at the central hub and the outer peripheral upstanding wall of seal 32. The current collector 28 contacts an outer negative cover 36 which forms the negative contact terminal of cell 10. The outer negative cover 36 is preferably formed of plated steel, and may be held in contact with current collector 28 via pressure contact or a weld. The outer negative cover 36 and inner cover 34 both have one or more vent openings, i.e., apertures, formed therein for allowing the release of pressurized gases during a cell venting condition.

As shown in FIG. 1, the electrochemical cell 10 may further comprise an electrical insulator 38 secured proximate the negative cover 36 of the electrochemical cell 10. The electrical insulator 38 extends around the periphery of the negative cover 36 and forms an insulating cover over at least a portion of the canister 12 located proximate to the negative cover 36. For example, the electrical insulator 38 may be generally ring-shaped, extending around a generally circular negative cover 36. Because the canister 12 is in electrical contact with the cathode 22 (and the positive terminal 18 when included) permitting an electrical conductor (e.g., such as an electrical contact within an electrical device, a metal coin, a metal key handled by a consumer, and/or the like) to simultaneously contact the negative cover 36 and a portion of the canister 12 would short-circuit the electrochemical cell 10. Thus, the electrical insulator 38 thereby serves to impede unintentional electrical connection between the canister 12 and the negative cover 36 by covering a portion of the canister 12 proximate the negative electrode 36. In the illustrated embodiment of FIG. 1, the electrical insulator 38 covers a portion of the canister 12 crimped over the annular seal 32 and the edges of the negative cover 36 such that a generally planar conductor (e.g., a planar metal plate) cannot contact both the negative electrode 36 and a portion of the canister 12 simultaneously.

In certain embodiments, the electrical insulator 38 comprises an insulating ring (e.g., a plastic ring) adhered to a portion of the canister 12 and/or the negative cover 36 (e.g., via an adhesive). In various embodiments, the electrical insulator 38 comprises an insulating coating (e.g., a varnish, a thermoplastic, a thermoset material, a rubber (natural and/or synthetic), a sealant (e.g., an ultraviolet-cured sealant), and/or the like) applied to a portion of the canister 12 and/or the negative cover 36. For example, the insulating coating may be sprayed onto the electrochemical cell and/or extruded onto the electrochemical cell, the electrochemical cell 10 may be dipped into a bath of insulating coating while the insulating coating is molten, and/or the like. The insulating coating may be cured, dried, set, and/or the like to create a solid and electrically insulating coating surrounding the perimeter of the negative cover 36. FIG. 2 is an end-on view of an electrochemical cell 10 showing an example position of the electrical insulator 38 relative to the canister 12 and the negative cover 36. In various embodiments, the electrical insulator 38 may have an ink-based printing thereon. For example, the electrical insulator 38 may be printed with an indication of cell polarity, cell brand information, and/or the like). In various embodiments, the electrical insulator 38 may be printed using compositions and/or methodologies as discussed herein, although any of a variety of printing methodologies and compositions may be used.

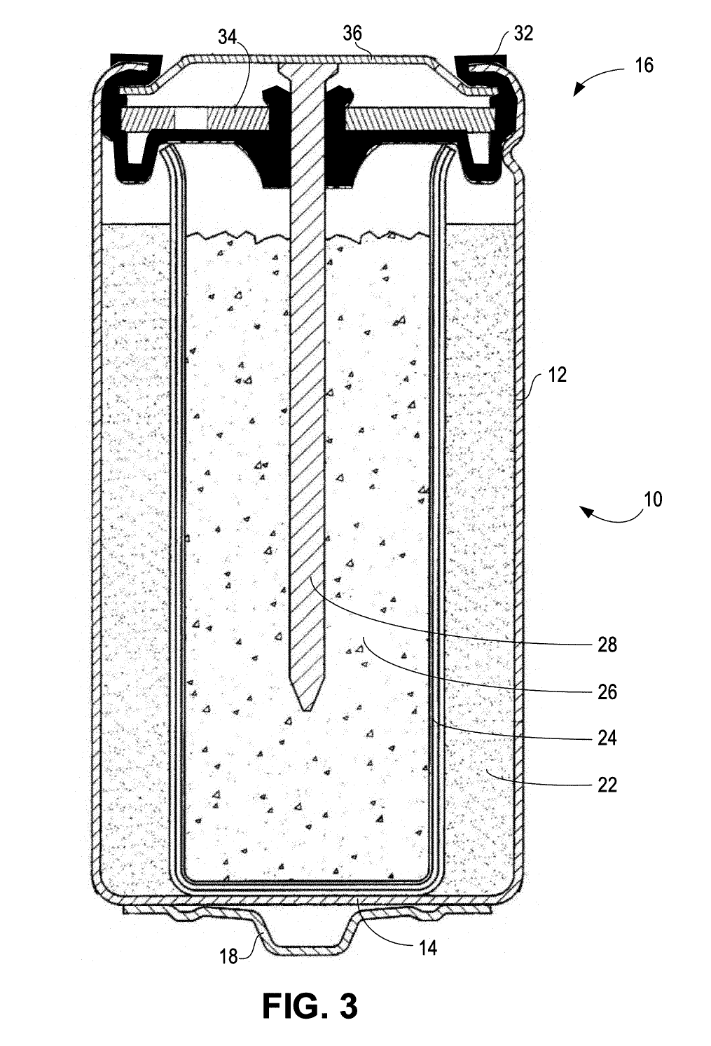

With reference briefly to FIG. 3, the annular seal 32 may extend around an open end of the canister 12 to form an electrical insulator on at least a portion of the exterior of the crimped canister 12 proximate the negative cover 36. The annular seal 32 forms a generally circular portion around the exterior of the canister 12. Accordingly, the annular seal 32 defines a groove extending around the interior of the canister 12 in which the open end of the canister 12 is placed, such that the exterior portion of the annular seal 32 covers the portion of the canister 12 proximate the negative cover 36.

The illustrated embodiments comprise indicia printed on an exterior surface of the canister 12. For example, the indicia may identify the brand of the electrochemical cell, required government and/or industry disclosures relevant to the electrochemical cell, instructions for use, terminal labels, size information, and/or the like. The indicia may be formed of ink and/or another optically visible composition that may be selectively applied to the exterior of the canister 12 (e.g., while in a liquid state) and cured, dried, and/or the like to secure the indicia relative to the canister 12.

The ink composition may be insoluble in an acidic electrolyte (e.g., KOH) such that, for example, the ink does not smear, smudge, drip, delaminate, and/or the like from the canister 12 if the electrolyte leaks from the interior of the cell. In certain embodiments, the ink composition may comprise a solvent based ink capable of adhering to the canister 12. For example, the ink composition may be configured to adhere to steel materials (e.g., steel alloys, carbon steel, stainless steel, and/or the like). As yet other examples, the ink composition may be configured to adhere to aluminum, zinc, and/or other materials that may be utilized to form a canister 12. In certain embodiments, the solvent based ink may be scratch-resistant, smudge resistant, and/or insoluble in KOH solution.

As yet other examples, the ink composition may comprise an eco-solvent based ink, a latex based ink, a UV-cure ink, and/or the like. As noted, the ink composition may be insoluble in KOH solution, such that the ink composition does not drip, smudge, or smear when exposed to KOH electrolyte from the interior of the cell. As yet another example, the ink composition may comprise an aqueous-based ink. In various embodiments, the ink composition may comprise two or more ink types to provide desired ink characteristics relative to the canister 12.

As yet another example, the ink composition may comprise a powder-coating thermoset composition configured to be applied onto the exterior surface of the canister 12 as a powder, and thermoset to bind onto the surface of the canister 12.

The ink composition may be printed onto the canister 12 via any of a variety of ink application methods. For example, the ink may be printed via direct lithography printing, indirect lithography printing (e.g., the lithographic image is printed onto a blanket roller before transferring onto the canister 12), inject printing, laser printing, screen printing, wet or dry-offset printing and/or the like. One or more ink colors may be applied to the canister 12 to form single or multi-color graphics. For example, each ink color may be applied by a separate ink roller, a separate ink jet, and/or the like. Multiple colors of ink may be applied simultaneously and/or in series. As discussed herein, the ink composition may be printed onto the canister 12 before the electrochemical material is added to the interior of the canister 12; after the electrochemical material is added to the interior of the canister 12; or before a canister blank is formed into the canister 12.

In various embodiments, the ink may be dried and/or cured to adhere the ink layer onto the exterior surface of the canister 12. For example, in embodiments utilizing a UV-cure ink, the canister 12 and printed ink composition is subject to a UV-light source for a period of time (e.g., 1 second, 0.5 seconds, and/or the like) to cure the ink onto the surface of the canister 12. As yet another example, the canister 12 may be heated (e.g., within an induction or thermal oven) to dry and/or cure the ink layer onto the canister 12.

With reference to FIG. 1A, which is a close-up cross-sectional view of a portion of the canister 12 within Section A of FIG. 1, the ink composition may be applied to an exterior surface of the canister 12 to form a printed ink layer 20a on an exterior surface of the canister 12. As shown in FIG. 1A, a final coating layer 20b may be applied over the printed ink layer 20a. The final coating layer 20b, which may comprise a clear (transparent or translucent) varnish or other clear coating layer (e.g., an epoxy, a urethane, a polyurethane, and/or the like). The final coating layer 20b may be configured to provide added physical and/or chemical stability for the printed ink layer 20a. The final coating layer 20b may be insoluble in a KOH electrolyte solution when dry and/or cured, thereby forming a protective clear barrier layer over the printed ink layer 20a.

Moreover, as shown in FIG. 1A, various embodiments may comprise one or more base coat and/or primer layers 20c between the printed ink layer 20a and the exterior surface of the canister 12. The primer layers 20c may comprise a coating configured to facilitate adhesion of the printed ink layer 20a onto the surface of the canister 12, to provide electrical insulation around the exterior of the canister 12, to inhibit corrosion of the canister 12, and/or to provide other desirable characteristics of the exterior surface of the canister. The primer layers 20c may be applied by spraying the exterior surface of the canister 12, immersing the canister into the primer layer material, rolling the primer layer 20c material onto the surface of the canister 12, electrochemically plating the primer layer 20c onto the surface of the canister 12, and/or the like. As non-limiting examples, the primer layers 20c may comprise a metallic coating (e.g., nickel), a UV coating, an aqueous coating, a solvent-based coating, and/or the like. In various embodiments, multiple primer layers 20c may be provided, each primer layer 20c being applied in series using one or more application methods. For example, a first primer layer immediately adjacent the canister may comprise a nickel coating and a second primer layer between the nickel coating and the printed ink layer 20a may comprise a primer configured to enable adhesion of the printed ink layer 20a with the nickel coating.

In various embodiments, the ink layer 20a, the final coating layer 20b, and/or the primer layer 20c may be printed and/or cured onto the canister 12 after the canister 12 is formed and/or before the canister 12 is filled with the various components of the electrochemical cell 10 (e.g., cathode material, separator, anode material, current collector, negative cover, and/or the like). However, it should be understood that the ink layer 20a, the final coating layer 20b, and/or the primer layer 20c may be printed and/or cured onto the canister 12 after the entire electrochemical cell 10 is formed (e.g., by filling, closing, and/or sealing the canister 12). As yet another example, the ink layer 20a, the final coating layer 20b, and/or the primer layer 20c may be printed and/or cured onto the canister 12 before the canister is formed. For example, the ink layer 20a, the final coating layer 20b, and/or the primer layer 20c may be distortion printed onto a canister blank before the canister blank is formed into the final shape of the canister 12. Accordingly, the ink layer 20a, the final coating layer 20b, and/or the primer layer 20c may be printed and/or cured onto the surface of the canister blank in a distorted manner (e.g., illegible to the human eye), and the ink layer 20a, the final coating layer 20b, and/or the primer layer 20c may thereafter be stretched into an undistorted configuration while the canister blank is formed into the final canister shape.

Collectively, the ink layer 20a the final coating layer 20b, and/or the primer layer 20c may have a thickness (e.g., measured between the exterior surface of the canister 12 and the exterior surface of the final coating layer 20b) of less than 50 microns. For example, the thickness of the ink layer 20a and the final coating layer 20b may be less than 25 microns, and more specifically less than 20 microns (e.g., between 1 and 20 microns; between 1 and 10 microns; less than 1 micron; and/or the like). Because the ink layer 20a, the final coating layer 20b, and/or the primer layer 20c have a collective thickness that is significantly thinner than historically utilized external labels, the overall diameter of the canister 12 may be increased when utilizing a direct-printed label in which the ink layer 20a and the final coating layer 20b are coated onto the canister 12 in place of an external label. Accordingly, the amount of space utilized for active electrochemical materials within the cell may be increased while the overall size of the electrochemical cell 10 remains within industry standards.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Although the foregoing description specifically describes features of a cylindrical alkaline electrochemical cell, it should be understood that various features described herein may be applicable to a plurality of other cell types, such as lithium-iron cells, lithium-ion cells, carbon-zinc cells, zinc-air cells, button-type cells, rectangular cells (e.g., 9V, PPE cells), and/or the like.

That which is claimed:

1. An electrochemical cell comprising:
a container having a closed bottom end, an open top end, and side walls extending between the bottom and top ends;
electrochemically active materials disposed in said container, said electrochemically active materials comprising a cathode and an anode, wherein the cathode is in electrical contact with the container; and
a negative cover disposed in the open top end of said container for closing the open top end of said container, wherein the negative cover is in electrical contact with the anode and the negative cover is electrically insulated from the container; and
wherein an external surface of the container has a printed indicia thereon, said printed indicia comprising an ink.

2. The electrochemical cell of claim 1, further comprising an insulating composition covering a portion of the container surrounding the negative cover such that a planar member cannot directly and simultaneously contact the container and the negative cover.

3. The electrochemical cell of claim 2, wherein the insulating composition comprises a plastic ring adhered to the portion of the container surrounding the negative cover.

4. The electrochemical cell of claim 2, wherein the insulating composition comprises at least one composition selected from: a thermoplastic, a thermoset material, an epoxy, a varnish, a UV-cured sealant, a urethane, a polyurethane, or a rubber.

5. The electrochemical cell of claim 2, wherein the insulating composition is defined by a portion of an annular seal configured to electrically insulate the negative cover from the container, wherein the portion of the annular seal extends around the open top of said container to cover at least a portion of the external surface of the container.

6. The electrochemical cell of claim 1, wherein the ink is selected from: a solvent-based ink, an aqueous-based ink, a UV-cure ink, an eco-solvent based ink, or a latex based ink.

7. The electrochemical cell of claim 1, further comprising a final coating layer external to the printed indicia.

8. The electrochemical cell of claim 7, wherein the final coating layer comprises a clear composition selected from: a varnish, an epoxy, a urethane, or a polyurethane.

9. The electrochemical cell of claim 1, further comprising a primer layer between the printed indicia and the external surface of the container.

10. The electrochemical cell of claim 1, wherein the closed bottom end of the container defines a protruding nub integrally formed with the container, the closed bottom end of the container defining a positive terminal of the electrochemical cell.

11. The electrochemical cell of claim 1, further comprising a positive terminal secured relative to the closed bottom end of the container, the positive terminal defining a protruding nub integrally formed with the positive terminal.

12. The electrochemical cell of claim 11, wherein the positive terminal is welded onto the closed bottom end of the container.

13. The electrochemical cell of claim 1, wherein the container comprises steel.

14. A method for forming an electrochemical cell, the method comprising:
providing a container having a closed bottom end, an open top end, and side walls extending between the bottom and top ends;
printing ink-based indicia onto an external surface of said side walls of said container;
positioning electrochemically active materials within said container, wherein the electrochemically active materials comprise a cathode and an anode;
placing a negative cover over the open top end of said container;
sealing the open top end of said container around the negative cover; and
forming an insulating composition on a portion of said side walls of said container around a perimeter of the negative cover.

15. The method of claim 14, wherein forming the insulating composition on a portion of said side walls of said container comprises adhering an insulating ring onto said portion of said side walls.

16. The method of claim 14, wherein forming the insulating composition on a portion of said side walls of said container comprises:
applying the insulating composition onto said portion of said sidewalls; and
curing the insulating composition such that the insulating composition adheres to said portion of said side walls.

17. The method of claim 16, wherein the insulating material comprises a thermoplastic, and wherein curing the insulating composition comprises cooling the insulating composition.

18. The method of claim 16, wherein the insulating material comprises a UV-cure material, and wherein curing the insulating composition comprises exposing the container to a UV-light.

19. The method of claim 14, further comprising applying a final coating layer onto the container, external to the printed ink-based indicia.

20. The method of claim 14, further comprising securing a positive terminal onto an external surface of the closed bottom end of the container, wherein the positive terminal defines a protruding nub integrally formed with the positive terminal.

21. The method of claim 20, wherein securing the positive terminal onto the external surface of the closed bottom end of the container comprises welding the positive terminal onto the external surface of the closed bottom end of the container.
